(19) United States
(12) Patent Application Publication
(10) Pub. No.: US 2015/0221286 A1
(43) Pub. Date: Aug. 6, 2015

(54) CONTENT CONTROLLED DISPLAY MODE SWITCHING

(71) Applicants: Alexander Hunt, Tygelsjo (SE); Daniel Lindstedt, Bunkeflostrand (SE)

(72) Inventors: Alexander Hunt, Tygelsjo (SE); Daniel Lindstedt, Bunkeflostrand (SE)

(73) Assignee: SONY CORPORATION, Tokyo (JP)

(21) Appl. No.: 14/173,419

(22) Filed: Feb. 5, 2014

(51) Int. Cl. G09G 5/36; G09G 5/00

(52) U.S. Cl. CPC G09G 5/366; G09G 5/006; G09G 2310/0232; G09G 2340/0407; G09G 2360/02; G09G 2370/04

(57) ABSTRACT

A computing device may be configured to display content based on the content type, and may include a display, a memory configured to store instructions, and at least one processor coupled to the display and the memory. The at least one processor may be configured to execute instructions stored in the memory to determine content information associated with a display mode, receive input display data associated with the content information, select a display mode based upon the determined content information, generate output display data based on the selected display mode and the input display data, and provide the output display data to the display based on the selected display mode. For example, the device may select interlace mode as a default mode for display, and may select progressive mode when the determined content information indicates the input display data is high quality video data.

### BACKGROUND INFORMATION

A computing device may include a display allowing a user to view a wide variety of different data types. The display may show information in the form of text, images, graphic objects (e.g., vector graphics), bitmaps, video, etc. The display may also provide graphic objects which can serve as Graphical User Interface (GUI) widgets permitting the user to enter input. However, conventional approaches for updating content on the displays of computing devices does not take into account the type of content being provided to the display.

### SUMMARY OF THE INVENTION

According to one aspect, a method for displaying content based on the content type may be performed by a computing device. The method may include determining content information associated with a display mode, and receiving input display data associated with the content information. The method may further include selecting a display mode based upon the determined content information, generating output display data based on the selected display mode and the input display data, and providing the output display data to the display based on the selected display mode.

Additionally, wherein determining content information further includes identifying a designation of an application which generates the input display data. Determining the content information may further include accessing an application list stored in memory.

Additionally, the method may further include selecting interlace mode as a default mode for display, and selecting progressive mode when the determined content information indicates the input display data is high quality video data.

Additionally, the selecting may be based on user defined default setting that overrides the selection based on determined content information, and wherein the user defined setting comprises a fixed display mode as an interlace mode or a progressive mode.

Additionally, when the selected display mode is an interlace mode, the method may further include generating alternating lines of output data to create a field for display. Moreover, each field may be displayed at a progressive mode frame rate.

Additionally, in another aspect, each field may be displayed at twice a progressive mode frame rate to reduce latency.

Additionally, the selected display mode may be a progressive mode, and further include generating sequential lines of output data to create a video frame for display.

In another aspect, a computing device may include a display, a memory configured to store instructions, and at least one processor coupled to the display and the memory. The at least one processor may be configured to execute the instructions stored in the memory to determine content information associated with a display mode, receive input display data associated with the content information, select a display mode based upon the determined content information, generate output display data based on the selected display mode and the input display data, and provide the output display data to the display based on the selected display mode.

Additionally, when determining content information, the processor is configured to identify a designation of an application which generates the input display data. When identifying, the processor is configured to access an application list stored in memory.

Additionally, the instructions may further cause the processor to select interlace mode as a default mode for display, and select progressive mode when the determined content information indicates the input display data is high quality video data.

Additionally, wherein when selecting a display mode, the processor is configured to select the display mode based on user defined default setting which overrides the selection based on the determined content information and set a fixed display mode as an interlace mode or a progressive mode.

Additionally, when the selected display mode selected is an interlace mode, the instructions may further cause the processor to generate alternating lines of output data to create a field for display.

Additionally, each field may be displayed at a progressive mode frame rate.

Additionally each field may be displayed at twice a progressive mode frame rate to reduce latency.

Additionally, when the selected display mode is a progressive mode, the instructions may further cause the processor to generate sequential lines of output data to create a video frame for display.

In another aspect, a computing device includes a display and logic which may be configured to determine content information associated with a display mode, receive input display data associated with the content information, select a display mode based upon the determined content information, generate output display data based on the selected display mode and the input display data, and provide the output display data to the display based on the selected display mode.

### BRIEF DESCRIPTION OF THE DRAWINGS

FIG. 1 is a diagram showing an exemplary computing device which may update a display based on a display mode control;

FIG. 2A is a diagram illustrating exemplary components of the computing device of FIG. 1;

FIG. 2B is a diagram depicting exemplary components and software modules stored in memory of the computing device of FIG. 1;

FIG. 3 is a diagram of showing exemplary functional components of a display mode controller for the computing device of FIG. 1; and

FIG. 4 is a flowchart of an exemplary process for updating a display based on the content being displayed.

### DETAILED DESCRIPTION

The following detailed description refers to the accompanying drawings. The same reference numbers in different drawings identify the same or similar elements.

A computing device may show a variety of different graphic data types on its display. For example, a home screen of a computing device, such as, for example, a smart phone, may include on its display a number of widgets for interacting with a user. As used herein, the term “home screen” may be a screen, which can be initially shown to a user upon powering up or waking up from sleep mode, that permits the user to access resources of the computing device. The widgets shown on the home screen may include objects that are static or dynamic, and can include images having low and/or high resolution, etc. The user may perform various interactions which result in the animation of the home screen, which can include animations showing the transitions of pages, zooming effects when launching applications, etc. For potential customers, a smooth, fast, and fluid movement can provide an outstanding first impression of the computing device. However, complex home screens having numerous animated items on the home screen can create a burden for the graphics hardware generating display frames when navigating between screens. This may manifest itself on the display by a jittery appearance in the movement of graphical items often caused by dropped frames. This can occur, for example, when the computing device cannot finish calculating a display frame in time for the display update.

In an exemplary implementation, one way to reduce the load on the graphics hardware associated with home screen animation is to generate the display using an interlace mode instead of a progressive mode (e.g., 1080i resolution instead of 1080p resolution). As used herein, providing a display using the interlace mode may involve generating video data by updating alternate lines corresponding to a single frame into two separate fields, where each field is consecutively displayed and includes half of the lines of the original frame. In the interlace mode, every other line in the frame may be updated. For example, the first field displayed may correspond to odd frame lines, and the second field displayed may correspond to even frame lines. This updating pattern of each odd and even field may repeat over the duration of the displayed video data. For a standard quality display, such as, for example, the home screen and/or control menus, the interlaced display will not be noticed by most users. Moreover, during animations of the home screen displayed in interlace mode, the movements will appear fluid and responsive because less data needs be updated to fluidly represent screen animations. In alternative implementations, the interlace mode may skip an arbitrary number of lines instead of every other line (e.g., every third, fourth, etc.) if image quality is not important and/or battery levels are low.

As used herein, providing a display using the progressive mode may involve generating video data by updating each line in a frame sequentially, thus each frame displayed includes both odd and even lines. However, using progressive mode to generate a display involves twice the amount of data, and thus places a greater burden on the graphics hardware. However, progressive mode may be more suitable for higher quality static images and for videos/movies displayed in full screen mode.

Accordingly, because no single display mode is best suited for all the types of data which may be shown by a computing device, the user experience may be improved by switching between progressive and interlace modes depending upon the graphics content to be displayed. Such changes in display mode may be dependent upon the application which produces the display data. If an application wants to emphasize speed and low latency, the interlace mode may be used. For applications focused on image quality, the progressive mode may be used.

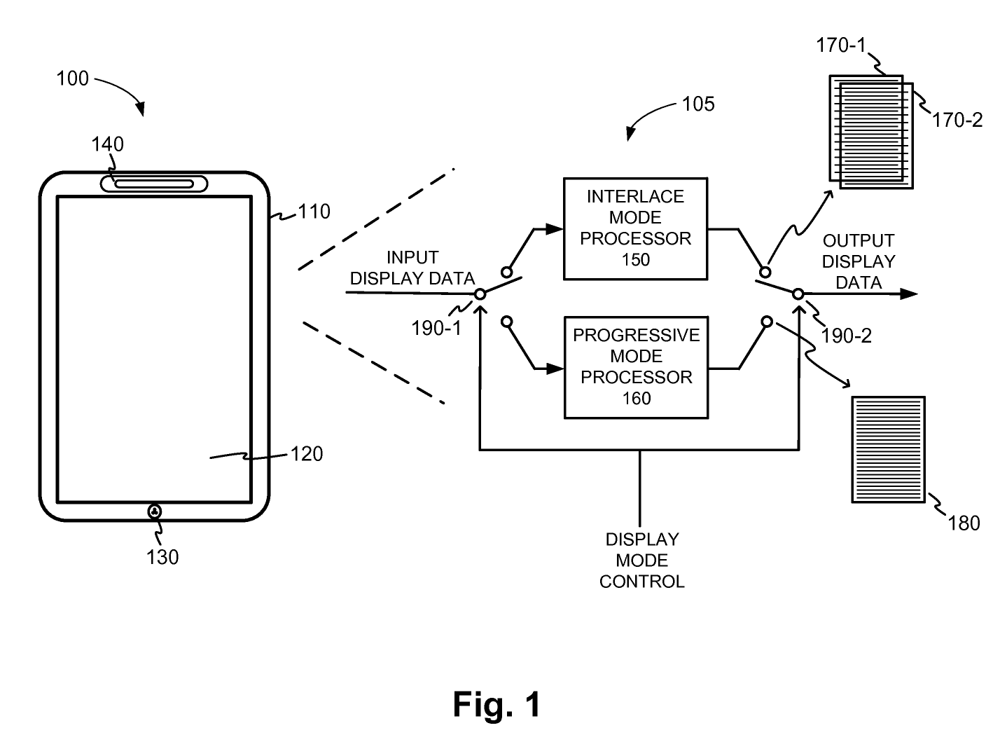

FIG. 1 is a diagram showing an exemplary computing device 100 which may update a display based on a display mode control. Computing device 100 may include any device with a display, such as a mobile phone, a smart phone, a phablet device, a tablet computer, a laptop computer, a personal computer, a personal digital assistant (PDA), a media playing device, and/or another type of portable communication device. As shown in FIG. 1, computing device 100 may include a housing 110, a display 120, a microphone 130, and a speaker 140. Further shown are functional blocks 105 which represent the operation of content controlled display mode switching, which may include an interlace mode processor 150, a progressive mode processor 160, and switches 190-1, 190-2 (herein referred to collectively as “switches 190” and individually as switch “190-x”).

Housing 110 may enclose computing device 100 and may protect the components from the outside environment. Display 120 may be a touchscreen, and thus incorporate a display device that includes an input device configured to detect a user's touch. For example, display 120 may include a liquid crystal display (LCD), an electronic ink display (e.g., an electrophoretic display), an electroluminescent display, and/or another type of display device. When configured as touchscreen display, display 120 may further include a set of touch sensors, such as a set of capacitive sensors (e.g., surface capacitive sensors, projected capacitive touch sensors, etc.), a set of resistive sensors (e.g., analog resistive sensors, digital resistive sensors, etc.), a set of optical sensors, etc. Further referring to computing device 100, microphone 130 may function as an input device that receives audio signals and converts the received audio signals to electrical signals. Speaker 140 may function as an output device that receives electrical signals and generates audio signals based on the received electrical signals. Computing device 100 may include additional sensors that are not shown in FIG. 1.

An aspect of the interior workings of computing device 100 with respect to content controlled display mode switching may be explained by the data flow associated with functional blocks 105. Input display data may be provided either to interlace mode processor 150 or progressive mode processor 160, depending upon the state of switches 190. The input display data may be generated by applications which produce text, graphics, and/or video/movie data. The state of switches 190 can be controlled by a display mode control, which may be based on the classification of the source (i.e., type of application) which generated the input display data. Depending upon the type of input display data, display mode control will select the appropriate mode of processing, either interlace mode or progressive mode, and provide the output display data to the display.

For example, if the input display data represented graphics associated with a home screen which is generated by the operating system, the display mode control may select switch 190-1 so the input display data is forwarded to interlace mode processor 150. The interlace mode processor 150 may, for example, provide output data including a first field 170-1, which may update odd numbered lines, and a second field 170-2, which may update even numbered lines. The fields 170-1 and 170-2 may be provided to display 120 by switch 190-2. The time spacing of fields' data 170-1 and 170-2 may be varied to produce desired effects. For example, fields 170-1 and 170-2 may be produced with the same timing as progressive mode frames 180 (e.g., every 16.7 milli-seconds, or 60 Hertz (Hz) rate). Because this approach would result in less graphics data being processed, the power consumption of computing device 100 may be reduced, thus saving battery energy which may be an advantage for mobile devices. Alternatively, fields 170-1 and 170-2 may be produced at twice the rate as progressive mode frames 180 (e.g., 8.33 milli-seconds, or at a 120 Hz rate), which may provide smooth transitions for fast moving animations. Alternatively, when the input display data includes higher quality graphics (e.g., high quality video, and/or movie data), display mode control may direct switch 190-1 to provide input display data to progressive mode processor 160, which will generate frame 180 as output display data. Frame 180, which will be directed to display 120 by switch 190-2 controlled by the display mode control signal, may be updated at a typical frame rate, such as, for example, every 16.67 milli-seconds.

Although FIG. 1 show exemplary components of computing device 100, in other implementations, computing device 100 may include fewer components, different components, differently arranged components, or additional components than depicted in FIG. 1. Additionally or alternatively, one or more components of computing device 100 may perform functions described as being performed by one or more other components of computing device 100.

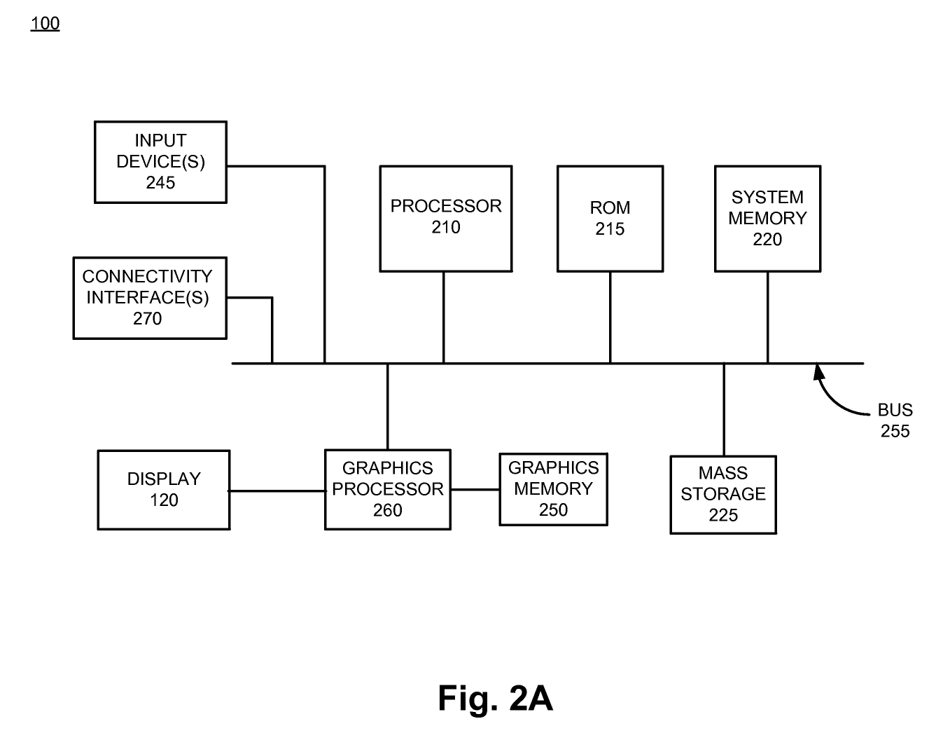

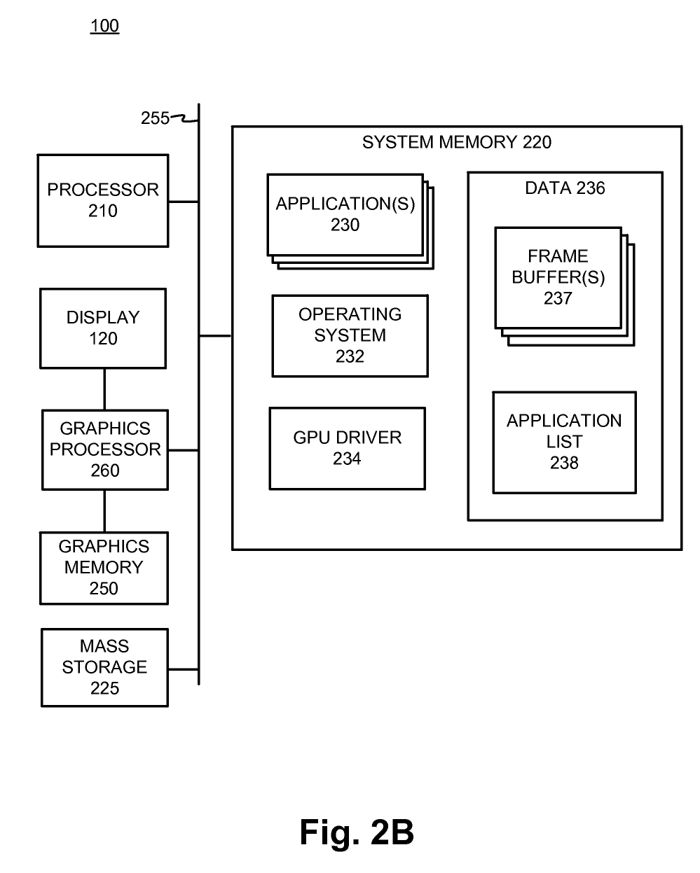

FIG. 2A is a diagram illustrating exemplary components of computing device 100 of FIG. 1. As shown in FIG. 2A, computing device 100 may include a bus 255, a processor 210, a ROM 215, system memory 220, mass storage 225, a display 120, input device(s) 245, a graphics memory 250, a bus 255, a graphics processor 260, and connectivity interface(s) 270.

Processor 210 may include a processor, microprocessor, or processing logic that may interpret and execute instructions. System memory 220 may include a random access memory (RAM) or another type of dynamic storage device that may store information and instructions for execution by processor 210. ROM 215 may include a ROM device or another type of static storage device that may store static information and instructions for use by processor 210. Mass storage 225 may include a solid state drive, a magnetic drive, and/or an optical drive.

Graphics processor 260 may be any type of processor configured to efficiently process graphics and/or video data, and may be coupled to fast graphics memory 250 over a separate high bandwidth interconnection. Graphics processor 260 may use graphics memory 250 to update the display for either interlace or progressive modes. Graphics memory 250 may be used for other graphics operations such as, for example, z-buffering. Graphics processor 260 may interface directly with display 120 to present output graphics data. Display 120 may be any type of display and/or touchscreen as described above in reference to FIG. 1.

Input device(s) 245 may include one or more mechanisms that permit an operator to input information to computing device 100, such as, for example, a keypad or a keyboard, a microphone 130, voice recognition, components for a touchscreen, and/or biometric mechanisms, etc.

Connectivity interface(s) 270 may include any transceiver mechanism that enables computing device 100 to communicate with other devices and/or systems. For example, connectivity interface(s) 270 may include mechanisms for communicating with another device or system via a network, such as cellular network (e.g., Long Term Evolution (LTE), LTE Advanced, etc.). Connectivity interface(s) 270 may include a transceiver that enables computing device 100 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Connectivity interface(s) 270 may include a transmitter that converts baseband signals to radio frequency (RF) signals and/or a receiver that converts RF signals to baseband signals. Connectivity interface(s) 270 may be coupled to an antenna assembly (not shown) for transmitting and receiving RF signals.

Connectivity interface(s) 270 may further include a logical component that includes input and/or output ports, input and/or output systems, and/or other input and output components that facilitate the transmission of data to other devices. For example, connectivity interface(s) 270 may include a network interface card (e.g., Ethernet card) for wired communications and/or a wireless network interface (e.g., a WiFi) card for wireless communications. Connectivity interface(s) 270 may also include a universal serial bus (USB) port for communications over a cable, a Bluetooth™ wireless interface, a radio-frequency identification (RFID) interface, a near-field communications (NFC) wireless interface, and/or any other type of interface that converts data from one form to another form.

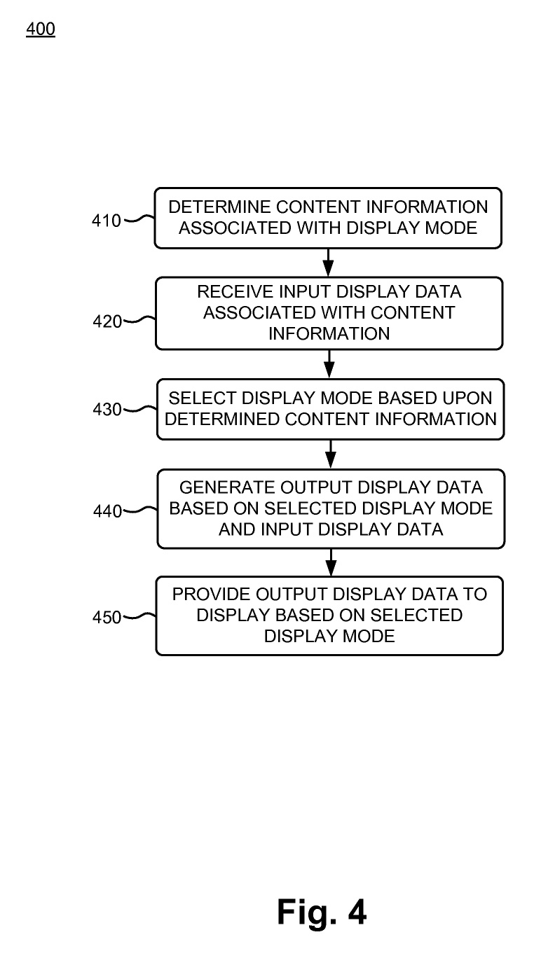

Computing device 100 may perform certain operations or processes, as may be described in detail below in FIG. 4. Computing device 100 may perform these operations in response to processor 210 and/or graphics processor 250 executing software instructions contained in a computer-readable medium, such as system memory 220 or graphics memory 250. A computer-readable medium may be defined as a physical or logical memory device. A logical memory device may include memory space within a single physical memory device or spread across multiple physical memory devices. The software instructions may be read into system memory 220 from another computer-readable medium, such as mass storage device 225, or from another device via connectivity interface(s) 270. The software instructions contained in system memory 220 or graphics memory 250 may cause processor 210 and/or graphics processor 260 to perform operations or processes described below. Alternatively, hardwired circuitry may be used in place of or in combination with software instructions to implement processes consistent with the principles of the embodiments. Thus, exemplary implementations are not limited to any specific combination of hardware circuitry and software.

The configuration of components of computing device 100 illustrated in FIG. 2A is for illustrative purposes only. It should be understood that other configurations may be implemented. Therefore, computing device 100 may include additional, fewer and/or different components than those depicted in FIG. 2A.

FIG. 2B is a diagram depicting exemplary components, software modules, and/or data that may be stored in system memory 220 of computing device 100. System memory 200 may store one or more application(s) 230, an operating system 232, a Graphics Processing Unit (GPU) driver 234, and data storage 236. Data storage 236 may include frame buffer(s) 237 and an application list 238. Additionally, storage for software modules and/or data may also be provided by mass storage 225. Moreover, mass storage 255 may further share storage with system memory 220 during the operation of computing device 100 (e.g., for memory paging, if needed).

Application(s) 230 may be programs which can provide higher layer functionality based upon inputs and/or commands provided by the user. Through operating system 232, applications 230 may interact with the user to receive a variety of user inputs, and in response, application(s) 230 may generate outputs which may include input display data. The “input display data” may be any type of graphics (including graphics directives and/or Applications Programming Interface (API) commands optimized for particular graphics processors 260), text, image, or video/movie data which may be processed by graphics processor 260. Graphics processor 260 subsequently generates “output display data” which may be provided to display 120.

In more detail, operating system 232 may coordinate the flow of the input display data produced by application(s) 230, so the input graphics data may be properly transferred to graphics processor 260 for subsequent high-speed graphics processing. In doing so, operating system 232 may utilize frame buffers 237 to buffer input display data, and interact with graphics processor 260 through GPU driver 234 over bus 255. Graphics processor 260 may obtain input graphics data via operating system 232, or be able to directly access input image data in frame buffer(s) 237 through GPU driver 234 using direct memory access to improve speed. Graphics processor 260 may utilize a high-speed graphics bus (not shown) for interacting with frame buffers 237 stored in system memory 220. In addition, graphics processor 260 may further use high-speed graphics memory which may co-located on the same board as graphics processor 260, to exchange data over a dedicated high-speed graphics memory interface. Graphics input processor may process the input display data and generate output display data which may be provided to display 120.

As noted above in the description of FIG. 1, the mechanism for determining how the input display data should be processed (i.e., using interlace mode or progressive mode) was explained as “switching” between the two modes based on a display mode control. In one exemplary implementation, the display mode control may be based on the type of input graphics data produced by each application 230. In one implementation, this may be determined by classifying each application 230 with the type of input graphics data it generates in application list 238. Accordingly, when a particular application 230 is being executed, processor 210 may look up the particular application in application list 238 to determine whether the input graphics data it produces is best displayed using interface mode or progressive mode. As used herein, the information stored in the application list may be referred to as “content information,” as it indicates the suitability of the input graphics data, produced by the application(s) 230, for a particular type of display mode (i.e., interlace or progressive). Once determined, processor 210 may subsequently use this information in its own processing, and also provide this information to graphics processor 260 so it may appropriately update the display with the proper display mode. In an alternative implementations, switching between update modes may occur within a single application depending upon what is being displayed. This may be performed, for example, by determining the data type of the input display data, or examining other meta-data associated which may be associated the input display data and/or the application.

As will be described below, content controlled display mode switching may be implemented in a number of different ways. In one exemplary implementation, GPU driver 234 will be able to utilize the content information provided by processor 210 via the application list 238. Here, GPU driver 234 may provide an interface so processor 210 (i.e., “host side”) may directly access graphics memory 250, thus processor 210 may send interlaced data to graphics memory 250 for processing by graphics processor 260. In this implementation, processor 210 will have to keep track of where in graphics memory 250 the lines that need to be updated. In another exemplary implementation, processor 210 may handle the interlaced data and only update every other line of the image in frame buffer 237 for interlaced mode.

In one aspect, when using interlace mode, half the amount of data is processed by computing device 100, which may allow the computing device 100 to run at lower clock speeds and/or use fewer processor 210 and graphics processor cores. In one exemplary implementation, when the amount of graphics data processed is lowered by a factor of 4, there is a system power consumption saving of over 30%. In some implementations, the selection of interlace mode or progressive mode may be based on the battery level of computing device 100.

In another aspect, the update speed of the computing device 100 may be increased by a factor of two when interlaced mode is used. In this implementation, the same amount of data may be processed in the system, but the system latency may be improved as graphics processor 260 may run at a higher speed. For example, display updates may occur every 8.33 milli-seconds (i.e., 120 Hz) instead of every 16.67 milli-seconds (i.e., 60 Hz). Such an implementation may enable graphics to be updated on the display 8.33 milli-seconds faster than the standard update rate.

As noted above, the processor 210 in conjunction with application list 238 may dynamically determine the mode for which the data produced by a particular application 230 is shown on display 120. For example, the default display mode may be set for interlace mode, and progressive mode is used when display quality is a concern (e.g., high quality video/move data). In another implementation, instead of using a “dynamic determination” of display mode as described above, a user may manually configure a setting to fix the updating to a particular display mode. For example, if a user is more concerned about display quality, the user may manually configure computing device 100 to display all data in progressive mode. Alternatively, if the user is concerned with power savings or smooth animations, the user may manually configure computing device 100 to display all data in interlace mode. In one implementation, computing device 100 may automatically perform all updates in interlace mode when the battery level is low.

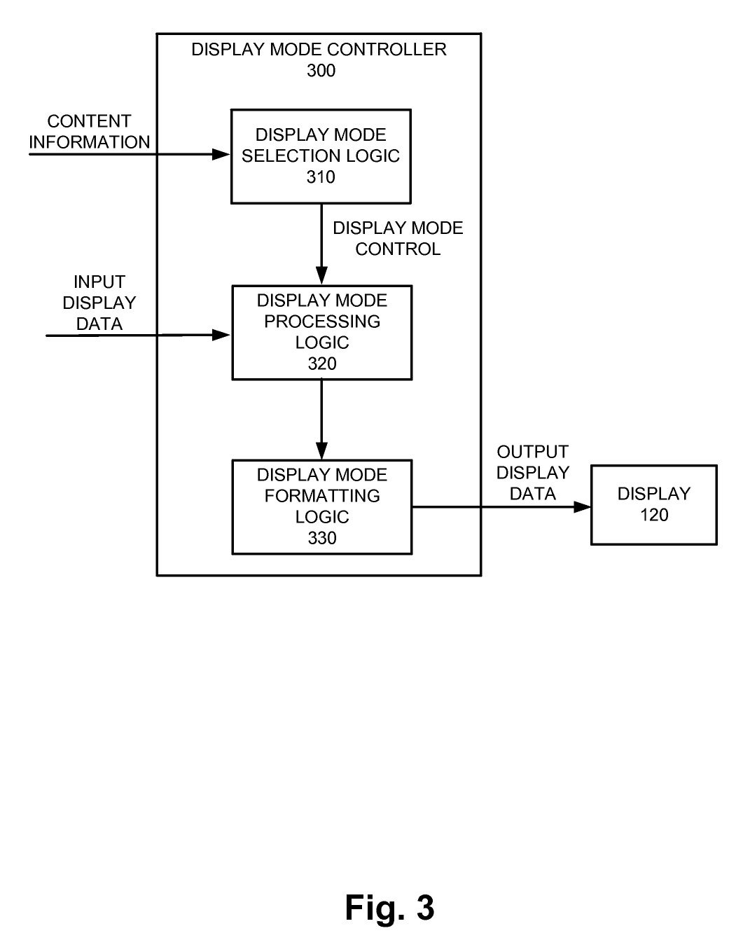

FIG. 3 is a diagram of showing exemplary functional components of a display mode controller 300 for computing device 100. The functional components of display mode controller 300 may be implemented, for example, via processor 210 executing instructions from memory 220, via graphics processor 260, or a combination thereof. Alternatively, some or all of the functional components of display mode controller 300 may be implemented via hard-wired circuitry. As shown in FIG. 3, display mode controller may include display mode section logic 310, display mode processing logic 320, and display mode formatting logic 330.

Display mode selection logic 310 may receive content information which may associate the input display data with a particular application 230, or an application type. Based on content information, display mode selection logic 310 determines an appropriate display mode for the input display data received from an application 230, and provides a display mode control signal for the display mode processing logic 320. The display mode processing logic 320 may further receive the input display data from application(s) 230, and process the input display data in accordance with the display mode indicated by the display mode control signal. For example, if interface mode has been selected, the display mode processing logic may perform filtering to reduce motion effects between interlaced fields. The processed input display data may be passed to display mode formatting logic 330, where fields are formatted if interlace mode was selected, and frames are formatted if progressive mode was selected. The display mode formatting logic 330 generates output display data which may be provided to display 120.

Although FIG. 3 shows exemplary functional components of computing device 100, in other implementations, computing device 100 may include fewer functional components, different functional components, differently arranged functional components, or additional functional components than depicted in FIG. 3. Additionally or alternatively, one or more functional components of computing device 100 may perform functions described as being performed by one or more other functional components of computer device 100.

FIG. 4 is a flowchart of an exemplary process 400 for updating a display based on the content being displayed. Process 400 shown in FIG. 4 may be performed by computing device 100. Computing device 100 may initially determine content information associated with a display mode (410). In an exemplary implementation, the content information may be based on a designation of a specific application which generates the input display data. Moreover, as discussed above in regards to FIG. 2B, the content information may be determined based on information stored in application list 238. In an exemplary implementation, the application list may be updated when applications are installed or removed from the computing device 100.

Computing device 100 may receive input display data associated with the content information (420). The input display data is generated by application(s) 230, and the association of the input data with the content information (e.g., data stored in application list 238) may be performed by processor 210.

The computing device 100 may then select a display mode based upon the determined content information (430). In an aspect, computing device 100 may select the interlace mode as a default mode for display, and select the progressive mode when the determined content information indicates the input display data is high quality video data (e.g., movies, live video feeds, etc.). In another aspect, the selection may be based on user defined default settings which can override the selection based on content information. The user defined default setting may set a fixed display mode as an interlace mode or a progressive mode. In another aspect, the computing device 100 may generate alternating lines of output data to create a field for display, where each field is displayed at a progressive mode frame rate to save power. In another aspect, computing device 100 may display each field at twice a progressive mode frame rate to reduce latency. In another aspect, computing device 100 may generate sequential lines of output data to create a video frame for display.

The computing device 100 may then generate output display data based on the selected display mode and the input display data (440). The output display data may be generated by graphics processor 260, which may provide the output display data to display 120 based on the selected display mode (450).

In the preceding specification, various implementations have been described with reference to the accompanying drawings. It will, however, be evident that various modifications and changes may be made thereto, and additional implementations may be provided, without departing from the broader scope of the invention as set forth in the claims that follow. The specification and drawings are accordingly to be regarded in an illustrative rather than restrictive sense.

For example, while series of blocks have been described with respect to FIG. 4, the order of the blocks may be modified in other implementations. Further, non-dependent blocks may be performed in parallel.

It will be apparent that systems and/or methods, as described above, may be implemented in many different forms of software, firmware, and hardware in the implementations illustrated in the figures. The actual software code or specialized control hardware used to realize these systems and methods is not limiting of the exemplary implementations. Thus, the operation and behavior of the devices and methods were described without reference to the specific software code, whereas it is understood that software and control hardware can be designed to implement the devices and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

The terms “comprises”/“comprising” when used in this specification are taken to specify the presence of stated features, integers, steps or components but does not preclude the presence or addition of one or more other features, integers, steps, components or groups thereof. Further, the term “exemplary” (e.g., “exemplary implementation,” “exemplary configuration,” etc.) means “as an example” and does not mean “preferred,” “best,” or likewise.

No element, act, or instruction used in the present application should be construed as critical or essential to the exemplary implementations unless explicitly described as such. Also, as used herein, the article “a” is intended to include one or more items. Further, the phrase “based on” is intended to mean “based, at least in part, on” unless explicitly stated otherwise.

What is claimed is:

1. A method for displaying content on a computing device based on content type, comprising:
determining content information associated with a display mode;
receiving input display data associated with the content information;
selecting a display mode based upon the determined content information;
generating output display data based on the selected display mode and the input display data; and
providing the output display data to the display based on the selected display mode.

2. The method of claim 1, wherein the determining content information comprises: identifying a designation of an application which generates the input display data.

3. The method of claim 2, wherein the determining content information comprises: accessing an application list stored in memory.

4. The method of claim 1, further comprising:
selecting interlace mode as a default mode for display; and
selecting progressive mode when the determined content information indicates the input display data is high quality video data.

5. The method of claim 4, wherein the selecting is based on a user defined default setting that overrides the selection based on the determined content information, and wherein the user defined setting comprises a fixed display mode as an interlace mode or a progressive mode.

6. The method of claim 1, wherein the selected display mode is an interlace mode, further comprising:
generating alternating lines of output data to create a field for display.

7. The method of claim 6, wherein each field is displayed at a progressive mode frame rate.

8. The method of claim 6, wherein each field is displayed at twice a progressive mode frame rate to reduce latency.

9. The method of claim 1, wherein the selected display mode is a progressive mode, further comprising:
generating sequential lines of output data to create a video frame for display.

10. A computing device, comprising:
a display;
a memory configured to store instructions; and
at least one processor, coupled to the display and the memory, wherein the at least one processor is configured to execute the instructions stored in the memory to:
determine content information associated with a display mode,
receive input display data associated with the content information,
select a display mode based upon the determined content information,
generate output display data based on the selected display mode and the input display data, and
provide the output display data to the display based on the selected display mode.

11. The computing device of claim 10, wherein when determining content information, the processor is configured to identify a designation of an application which generates the input display data.

12. The computing device of claim 11, when identifying, the processor is configured to access an application list stored in memory.

13. The computing device of claim 12, wherein the processor is configured to update the application list is updated when applications are installed on the computing device.

14. The computing device of claim 10, wherein the instructions further cause the processor to:
select interlace mode as a default mode for display, and
select progressive mode when the determined content information indicates the input display data is high quality video data.

15. The computing device of claim 14, wherein when selecting a display mode, the processor is configured to the select the display mode based on user defined default setting which overrides the selection based on the determined content information and set a fixed display mode as an interlace mode or a progressive mode.

16. The computing device of claim 10, wherein when the selected display mode is an interlace mode, the instructions further cause the processor to:
generate alternating lines of output data to create a field for display.

17. The computing device of claim 16, wherein each field is displayed at a progressive mode frame rate.

18. The computing device of claim 17, wherein each field is displayed at twice a progressive mode frame rate to reduce latency.

19. The computing device of claim 10, wherein when the selected display mode is a progressive mode, the instructions further cause the processor to:
generate sequential lines of output data to create a video frame for display.

20. A computing device, comprising:
a display; and
logic configured to:
determine content information associated with a display mode,
receive input display data associated with the content information,
select a display mode based upon the determined content information,
generate output display data based on the selected display mode and the input display data, and
provide the output display data to the display based on the selected display mode.
